(19) United States
(12) Patent Application Publication
(10) Pub. No.: US 2008/0161040 A1
(43) Pub. Date: Jul. 3, 2008

(54) SYSTEMS AND METHODS FOR CONFIGURING AND OPERATING A CELLULAR TELEPHONE AS A CORDLESS TELEPHONE HANDSET

(75) Inventors: Leonardo William Estevez, Rowlett, TX (US); Dongan Zhang, Plano, TX (US); Thomas Francis Flanagan, Springfield, VA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/618,173

(22) Filed: Dec. 29, 2006

(51) Int. Cl. H04M 1/00

(52) U.S. Cl. 455/553.1

(57) ABSTRACT

The present disclosure describes systems and methods for configuring and operating a cellular telephone as a cordless telephone handset. Some illustrative embodiments may include a communications device that includes a cellular telephone radio frequency (RF) transceiver, a radio frequency identification (RFID) transceiver; and control logic coupled to the cellular telephone RE transceiver and the RFID transceiver. The control logic configures the RFID transceiver and enables the communications device to communicate with a cordless telephone base station.

### BACKGROUND

Cellular and cordless telephones are devices that have experienced wide acceptance and use by the general public. Both devices provide telephone communications capabilities, and both use radio frequency (RF) technology to operate. But cellular telephones are designed to provide RF communications with a collection of shared terrestrial base stations that are coupled to a communications network and that are distributed over a large geographic area. By contrast, cordless telephones are designed to provide RF communications with a single, dedicated base station coupled to a communications network over a relatively short distance, usually no more than a few hundred feet.

As a result of these differences, cordless telephones are generally not viewed as adequate substitutes for cellular telephones, but cellular telephones are sometimes viewed as adequate substitutes for cordless telephones. Nonetheless, for some cellular telephone users reception and reliability problems with their cellular service at their home or office may preclude the use of cellular telephones. As a result, such users may need both a cordless telephone and a cellular telephone if they wish to have wireless telecommunications capabilities at all times and at all locations.

### SUMMARY

The present disclosure describes systems and methods for configuring and operating a cellular telephone as a cordless telephone handset. Some illustrative embodiments may include a communications device that includes a cellular telephone radio frequency (RF) transceiver, a radio frequency identification (RFID) transceiver; and control logic coupled to the cellular telephone RF transceiver and the RFID transceiver. The control logic configures the RFID transceiver and enables the communications device to communicate with a cordless telephone base station.

Other illustrative embodiments may include a method for configuring and operating a communications device. Such a method includes causing an RFID transceiver within the communications device to operate so as to be capable of communicating with a cordless telephone base station through the RFID transceiver.

Yet further illustrative embodiments may include an information carrier medium comprising software that can be executed on a processor to cause the processor to configure an RFID transceiver within a communications device to operate so as to allow the communications device to communicate with a cordless telephone base station through the RFID transceiver.

### BRIEF DESCRIPTION OF THE DRAWINGS

For a detailed description of the preferred embodiments of the invention, reference will now be made to the accompanying drawings in which:

FIG. 1 depicts a cellular telephone capable of communicating with both a cellular telephone system and a cordless telephone base station, in accordance with at least some illustrative embodiments;

FIG. 2 depicts a cordless telephone that includes an RFID transceiver, in accordance with at least some illustrative embodiments; and

FIG. 3 depicts a method for configuring a cellular telephone to emulate a cordless telephone handset, in accordance with at least some illustrative embodiments.

### NOTATION AND NOMENCLATURE

Certain terms are used throughout the following discussion and claims to refer to particular system components. This document does not intend to distinguish between components that differ in name but not function. In the following discussion and in the claims, the terms “including” and “comprising” are used in an open-ended fashion, and thus should be interpreted to mean “including but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “system” refers to a collection of two or more hardware and/or software components, and may be used to refer to an electronic device, such as a communications system or a portion of a communications system. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

In recent years cellular telephones have begun to incorporate programmable radio frequency identification (RFID) technology for use with a variety of services (e.g., inventory control, sales, advertising, and online credit card purchases). RFID devices are designed to operate in a number of radio frequency (RF) bands, including an RF band known as the Industrial, Scientific and Medical (ISM) band This RF band is also assigned for use by cordless telephone systems. As a result, it is possible to reconfigure and use the RFID transceivers already present within some cellular telephones to communicate with at least some existing cordless telephone base stations.

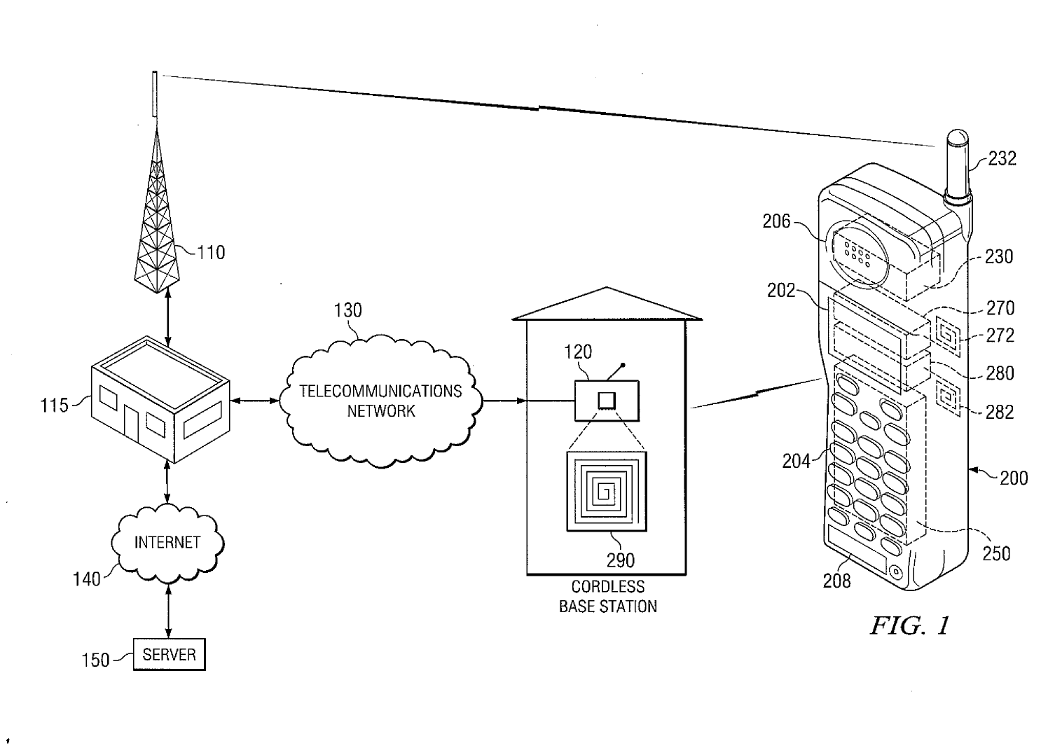

FIG. 1 illustrates a cellular telephone 200 constructed in accordance with at least some preferred embodiments. Cellular telephone 200 comprises a processing subsystem 250, which is operated by a user via keypad 204 and display 202. Processing subsystem 250 controls and monitors cellular RF transceiver 230, which provides RF communications with cell tower 110 via cellular antenna 232, and thus provides a path to telecommunications network 130. Processing subsystem 250 also controls and monitors UHF RF transceiver 270, which provides ultra high frequency (UHF, i.e., radio frequency signals ranging from 300 MHz to 3 GHz) RF communications with cordless base station 120 via UHF RF antenna 272, thus providing another path to telecommunications network 130. Processing subsystem 250 further controls and monitors HF RFID transceiver 280, which provides high frequency (HF, i.e., radio frequency signals ranging from 3 MHz to 30 MHz) RF communications with HF RFID tags and transceivers (e.g., RFID tag 290 within cordless telephone base station 120). Cellular telephone 200 also comprises speaker 206 and microphone 208, which allow the user to engage in voice communications over the telecommunications network once a connection has been established to the network over one of the RF paths described.

In addition, cellular telephone 200 can also access Internet 140 and servers accessible on the Internet such as server 150 using the cellular RF link to cellular tower 110. Network interface equipment 115, which may be either co-located with cell tower 110 or within a central exchange office at another location, splits and mergers voice and data traffic to and from the Internet 140 and telecommunications network 130. This enables the cellular telephone 200 to download data and programs (e.g., ringtones and games) from servers on the Internet.

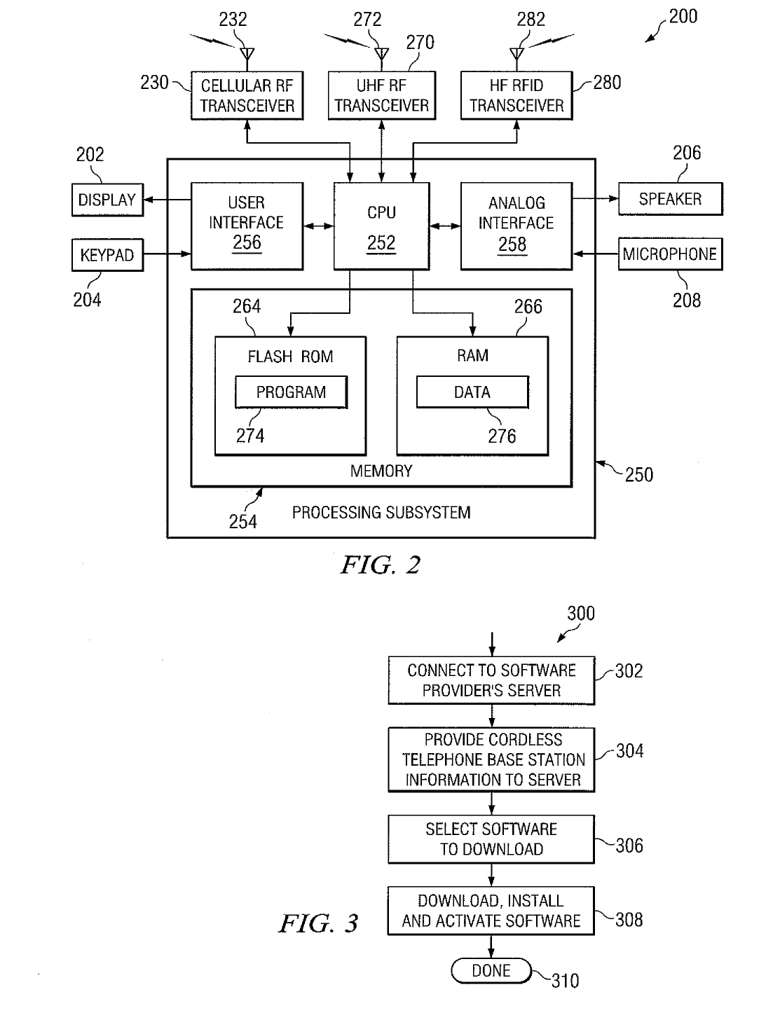

FIG. 2 illustrates some of the details of cellular telephone 200, constructed in accordance with at least some of the preferred embodiments. Processing subsystem 250 comprises a CPU 252 that is coupled to memory 254, and which is capable of executing a program stored in memory 254. In at least some of the preferred embodiments, memory 254 is a combination of both volatile memory such as random access memory (RAM) 266, and non-volatile, programmable memory such as Flash read-only memory (Flash ROM) 264. Program 274, for example, is stored in non-volatile memory, which when executed by the CPU can store and access data 276 that is stored in RAM 266.

CPU 252 also couples to user interface logic (User I/F) 256, which in turn couples to display 202 and keypad 204. User interface logic 256 receives keypad data entered by the user and forwards it to CPU 252 for processing. CPU 252 also sends data to user interface logic 256, which forwards the data to display 202 for presentation to the user. Similarly, processing subsystem also comprises analog interface 258, which couples to CPU 252. CPU provides digitally encoded analog data to analog interface (Analog I/F) 258, which converts the data to audio. Analog interface couples to speaker 206 and provides the analog audio to speaker 206, making it audible to the user. The user may also speak into microphone 208, which also couples to analog interface 258. Audio detected by microphone 208 is converted by analog interface 258 into digitally encoded audio, which is forwarded to CPU 252 for processing.

Continuing to refer to the illustrative embodiment of FIG. 2, CPU 252 also couples to cellular RF transceiver 230, which couples to cellular antenna 232 and transmits information received from CPU 252 as a modulated RF signal via cellular antenna 232. Cellular RF transceiver 230 also receives modulated RF signals via cellular antenna 232 and demodulates the signal to extract the encoded information. This extracted information is then forwarded for processing to CPU 252. Alternatively, CPU 252 may execute software that modulates and/or demodulates the transmitted and received signals respectively, working in conjunction with cellular transceiver 230 to perform these functions. Both the transmitted and received information may include digital data, as well as digitally encoded audio. The modulated RF signals transmitted and received by the cellular RF transceiver are at frequencies that are within one or more of the bands designated for cellular telephone communications.

CPU 252 similarly couples to UHF RF transceiver 270, which couples to UHF RF antenna 272 and transmits information received from CPU 252 as a modulated UHF RF signal via RF antenna 272. UHF RF transceiver 270 also receives modulated UHF RF signals via UHF RF antenna 272 and demodulates the signal to extract the encoded information. This information is then forwarded for processing to CPU 252. As noted above with regard to cellular RF transceiver 230, CPU 252 may work in conjunction with UHF RF transceiver 270 by executing software that modulates and/or demodulates the signals transmitted and received by UHF RF transceiver 270. Information sent to and received from UHF RFID transceiver 270 may include both digital data, as well as digitally encoded audio. The modulated RF signals transmitted and received by UHF RF transceiver 270 are at frequencies that are within the ISM band designated for both UHF RFID and cordless telephone use. Further, both UHF RFID and cordless telephone transmitters and receivers are capable of similar signal modulation modes. Thus, for example, both a UHF RFID transceiver and a cordless telephone are capable of transmitting and receiving modulated signals in the 900 MHz range, and both can be configured to use spread spectrum modulation.

CPU 252 further couples to HF RFID transceiver 280, which couples to HF RFID antenna 282 and transmits information received from CPU 252 as a modulated HF RF signal via HF RFID antenna 282. HF RFID transceiver 280 also receives modulated HF RF signals via HF RFID antenna 282 and demodulates the signal to extract the encoded information. This information is then forwarded for processing to CPU 252. As noted above with regard to cellular RF transceiver 230, CPU 252 may work in conjunction with HF RFID transceiver 280 by executing software that modulates and/or demodulates the signals transmitted and received by HF RFID transceiver 280. HF RFID transceiver 280 allows cellular telephone 200 to interact with HF RFID tags, independent of whether UHF RFID transceiver is configured as a cordless telephone transceiver or a UHF RFID transceiver. In at least some preferred embodiments, a single RFID transceiver is used (not shown) that is capable of multi-band operation, including both the HF and UHF bands, thus making the single transceiver capable of interacting with a cordless telephone base station, as well as HF and UHF RFID tags and transceivers (depending on how the transceiver is configured). In at least some other preferred embodiments, a single dual-mode UHF transceiver is used to provide both UHF communications with the cordless telephone base station, as well as the ability to interact with UHF RFID tags. Other combinations of bands, modes and transceivers will become apparent to those skilled in the art, and all such combinations are intended to be within the scope of the present disclosure.

In at least some of the preferred embodiments, UHF RFID transceiver 270 may be programmed by CPU 252. Software executing on CPU 252 causes the CPU to configure the transmit and receiver carrier frequencies which UHF RFID transceiver 270 utilizes to operate, as well as the transmit modulation and receive demodulation modes used (e.g., discrete multi-tone and spread spectrum modulation modes). Software executing on CPU 252 may also cause the CPU to configure the order in which frequencies are selected, as well as the duration or dwell time at those frequencies, if, for example, a spread spectrum mode is selected. Other UHF RFID transceiver parameters may also be configured by the CPU 252, and the present disclosure is intended to encompass all embodiments that include such additional parameters. Also, as already noted, software executing on CPU 252 may participate, in whole or in part, in the modulation and demodulation of the transmitted and received UHF RFID signals. Such software may also be configured to operate according to a wide variety of RF modulation and transmission parameters and configuration options, and all such parameters and options are also intended to be within the scope of the present disclosure. Further, the configuration parameters may also include base-station-specific parameters, such as, for example, a security code included in a transmitted message to or from the cordless telephone base station and used by the receiver of the message to authenticate the transmitted message.

Because CPU 252 can be used to configure UHF RFID transceiver 270 and/or modulation software executing on CPU 252, it is possible to download and install, or otherwise provide, a program that allows cellular telephone 200 to communicate with an existing cordless telephone base station. As already noted, cordless telephones operate in the same ISM band as UHF RFID systems. By configuring the UHF RFID transceiver and/or modulation software appropriately, the cellular telephone can be made to appear to the base station as if it were a handset designed and configured to communicate with the base station. FIG. 3 illustrates method 300, in accordance with at least some preferred embodiments, for configuring and operating a cellular telephone so as to emulate a cordless telephone handset. The user begins by connecting to a server operated by a provider of the software needed by the cellular telephone to emulate a cordless telephone handset (block 302). This may be done directly on the cellular telephone using a web interface, or using another device with internet access (e.g., a personal computer). Once connected, the user provides the server with information used to identify the base station with which the cellular telephone will interact (block 304). In at least some preferred embodiments, this information is provided by the user using an RFID tag embedded within the cordless telephone base station, which is read by the RFID transceiver within the cellular telephone. This information may include the manufacturer's name and the base station ID (a code used to identify individual base stations). The information may also include a link (e.g., a URL to an Internet site) from which the cellular telephone can download additional information based on the information collected from the RFID tag.

Once the base station has been identified by the server, the communications software to be downloaded to the cellular telephone is selected (block 306). In at least some preferred embodiments, the selection is automatically made based upon the identification information collected (e.g., from the RFID tag within the cordless telephone base station). In at least some other preferred embodiments, the selection is made by the user, wherein the user is presented with different communications software downloads, each with different optional features and prices. Such optional features may include, for example, a call waiting feature that allows a call from one source (e.g., the cellular system) to be put on hold, while a call from the other source (e.g., the cordless telephone base station) is answered using the cellular telephone. Many other optional features and combinations of features will become apparent to those skilled in the art, and all such features and combinations are intended to be within the scope of the present disclosure.

After the communications software is selected, the software is downloaded, installed and activated (block 308). As already noted, downloading, installing and activating the software may be initiated by the user directly on the cellular telephone receiving the software download via a web interface on the cellular telephone, indirectly through a web browser running on another device (e.g., a personal computer), or automatically with little or no user intervention. If another device is used by the user to initiate the transfer, the user needs to provide the software provider's server with sufficient information to locate and connect to the cellular telephone. This may include such information as the name of the service provider and the telephone number associated with the cellular telephone. Once the software is downloaded, installed and activated, the method 300 is complete (block 310).

Upon activation of the software, a variety of operational modes are possible. For example, in at least some illustrative embodiments, the cellular phone may be configured to select between operating as a cellular phone or as a handset of a cordless telephone. Selection of an operational mode may be user initiated through a configurable button or menu item accessible through the user interface of the cellular phone, or may occur automatically when the signal from the cordless telephone base station is detected and authenticated. Alternatively, concurrent cellular and cordless operation may be enabled, allowing calls to be initiated or received via either the cellular telephone system, or the ground-based telecommunications network coupled to the cordless telephone base station. In at least some illustrative embodiments a user may receive a call on one system (e.g., the cellular system), then receive an indication that a call is being received from the other system (e.g., via the cordless base station). The user may then transition from one call to another using a call waiting switch hook flash, or by using a flash button provided on the phone.

The above disclosure is meant to be illustrative of the principles and various embodiments of the present invention. Numerous variations and modifications will become apparent to those skilled in the art once the above disclosure is fully appreciated. For example, the data paths made available by both the cellular telephone and telecommunications networks can be used concurrently, rather than separately. This may allow high bandwidth applications, such as high quality audio and/or video, to execute on, or transfer data through, the cellular telephone of the illustrative embodiments described. Such applications may create multiplexed data paths through both networks, or may segregate the information based upon the bandwidth requirements (e.g., transferring audio data through the cellular network while sending video data through the telecommunications network). Also, although the embodiments described include one or more processors executing software, other embodiments may include control logic other than a processor (e.g., a programmable logic array implementing a state machine) that may or may not execute software. It is intended that the following claims be interpreted to embrace all such variations and modifications.

What is claimed is:

1. A communications device, comprising:
a cellular telephone radio frequency (RF) transceiver;
a radio frequency identification (RFID) transceiver; and
control logic coupled to the cellular telephone RF transceiver and the REID transceiver;
wherein the control logic configures the RFID transceiver and enables the communications device to communicate with a cordless telephone base station.

2. The communications device of claim 1, wherein the control logic comprises a processor, and wherein at least part of a communications software program executes on the processor and causes the processor to configure the RFID transceiver.

3. The communications device of claim 2, wherein the RFID transceiver comprises a second processor, and wherein at least part of a communications software program executes on the second processor and causes the second processor to configure the RFID transceiver.

4. The communications device of claim 2, wherein the communications software program is downloaded to the communications device through the cellular telephone RF transceiver from a server.

5. The communications device of claim 4, wherein the downloaded communications software program is selected based upon information stored within an RFID tag, the tag providing the stored information to the communications device via the RFID transceiver.

6. The communications device of claim 4, wherein the downloaded communications software program is selected based upon an identification code associated with the cordless telephone base station.

7. The communications device of claim 4, wherein a user causes the communications software program to be downloaded by operating user interface software executing on the processor.

8. The communications device of claim 4, wherein a user causes the communications software program to be downloaded by operating user interface software executing on a computer system that does not comprise the communications device.

9. The communications device of claim 1, wherein the control logic selects one or more transmit carrier frequencies included in a first RF signal transmitted by the RFID transceiver, and further selects one or more receive carrier frequencies included in a second RF signal received by the RFID transceiver.

10. The communications device of claim 1, wherein the control logic selects a transmit modulation mode applied to a first RF signal transmitted by the RFID transceiver, and further selects a receive demodulation mode applied to a second RF signal received by the RFID transceiver.

11. The communications device of claim 1, wherein the control logic causes a security code associated with the cordless telephone base station to be encoded within messages transmitted by the RFID transceiver; and wherein the control logic further uses the security code to authenticate messages received by the RFID transceiver.

12. The communications device of claim 1, wherein the control logic causes the communications device to transmit and receive data concurrently through both the cellular telephone RF transceiver and the RFID transceiver.

13. A method for configuring and operating a communications device, comprising causing an RFID transceiver within a communications device to operate so as to be capable of communicating with a cordless telephone base station.

14. The method of claim 13, further comprising initiating a download of software to the communications device by operating a user interface on the communications device, the downloaded software causing the RFID transceiver to be capable of communicating with the cordless telephone base station.

15. The method of claim 13, further comprising initiating a download of software to the communications device by operating a user interface on a computer system not comprising the communications device, the downloaded software causing the RFID transceiver to be capable of communicating with the cordless telephone base station.

16. The method of claim 13, further comprising selecting software to be downloaded to the communications device based upon information associated with the cordless telephone base station.

17. The method of claim 13, further comprising using the RFID transceiver to read information stored on an RFID tag, and selecting software to be downloaded to the communications device based upon information read from the RFID tag.

18. The method of claim 13, further comprising:
selecting one or more transmit carrier frequencies included in a first RF signal transmitted by the RFID transceiver; and
selecting one or more receive carrier frequencies included in a second RF signal received by the RFID transceiver.

19. The method of claim 13, further comprising:
selecting a transmit modulation mode applied to a first RF signal transmitted by the RFID transceiver; and
selecting a receive demodulation mode applied to a second RF signal received by the RFID transceiver.

20. The method of claim 13, further comprising:
including a security code within a transmitted message, the security code associated with the cordless telephone bas station; and
authenticating a received message by verifying the presence of the security code within the received message.

21. The method of claim 13, further comprising concurrently transmitting and receiving data via both the RFID transceiver and a cellular telephone RF transceiver within the communications device.

22. An information carrier medium comprising software that can be executed on a processor to cause the processor to configure an RFID transceiver within a communications device to operate so as to allow the communications device to communicate with a cordless telephone base station through the RFID transceiver.

23. The information carrier medium of claim 22, wherein the software further causes the processor to:
select one or more transmit carrier frequencies included in a first RF signal transmitted by the RFID transceiver; and
select one or more receive carrier frequencies included in a second RF signal received by the RFID transceiver.

24. The information carrier medium of claim 22, wherein the software further causes the processor to:
select a transmit modulation mode applied to a first RF signal transmitted by the RFID transceiver; and
select a receive demodulation mode applied to a second RF signal received by the RFID transceiver.

25. The information carrier medium of claim 22, wherein the software further causes the processor to:
include a security code within a transmitted message, the security code associated with the cordless telephone bas station; and
authenticate a received message by verifying the presence of the security code within the received message.

26. The information carrier medium of claim 22, wherein the software further causes the processor to concurrently transmit and receive data via the RFID transceiver and via a cellular telephone RF transceiver within the communications device.
